(19) United States
(12) Patent Application Publication
(10) Pub. No.: US 2008/0018261 A1
(43) Pub. Date: Jan. 24, 2008

(54) LED power supply with options for dimming

(76) Inventor: Mark Allen Kastner, New Berlin, WI (US)

Correspondence Address: Attorney Richard S. Missimer, PO Box 486, Butler, WI, 53007-0486, US

(21) Appl. No.: 11/796,940

(22) Filed: Apr. 30, 2007

Related U.S. Application Data
(60) Provisional application No. 60/796,583, filed on May 1, 2006.

(51) Int. Cl. H05B 37/02

(52) U.S. Cl. 315/192

(57) ABSTRACT

A LED driver circuit is disclosed that has the ability to drive a single series string of power LEDs. The LED driver circuit uses a single stage power converter to convert from a universal AC input to a regulated DC current. This single stage power converter current is controlled by a power factor correction unit. Furthermore, the LED driver circuit contains a galvanic isolation barrier that isolates an input, or primary, section from an output, or secondary, section. The LED driver circuit can also include a dimming function, a red, green, blue output function, and a control signal that indicates the LED current and is sent from the secondary to the primary side of the galvanic barrier.

### BACKGROUND OF INVENTION

Since their commercial appearance in the 1960's, light emitting diodes (LED) have become ubiquitous in electronic devices. Traditionally, LED light output was ideal for indicator applications but insufficient for general illumination. However, in recent years a great advance in the development of high-intensity LEDs has occurred. These new LEDs operate at much higher current levels than their predecessors (350 milliamps to several amperes compared to the 10-50 milliamp range for traditional LEDs). These new power LEDs produce sufficient output to make them practical as sources of illumination.

Presently, the high cost of the new power LEDs renders them best suited for applications where the unique characteristics of LEDs (ruggedness, long life, etc.) offset the extra expense. However, the cost of these high power LEDs continues to fall while efficiency (light output per unit of electrical energy in) continues to rise. Predictions are that in the near future, LEDs will be the source for general illumination, preferred over incandescent, florescent, and other arc-discharge lamps.

LEDs are a type of semiconductor device requiring direct current (DC) for operation. For optimum light output and reliability, that direct current should have a low ripple content. Since the power grid delivers alternating current (AC), a line-powered device must convert the AC to DC to power the LEDs. This conversion is called rectification. The rectifying device, or rectifier, must also operate without modification or adjustment under multiple input conditions, such as the 50- or 60-Hz utility power frequency provided in different geographic areas.

Further, LEDs are current driven rather than voltage driven devices. The driving circuit must regulate the current more precisely than the voltage supplied to the device terminals. The current regulation requirement imposes special considerations in the design of LED power supplies; most power supplies are designed to regulate voltage. Indeed, the design of the majority of integrated circuits (IC) commercially available for controlling power supplies is for voltage regulation.

Another increasingly common requirement for line-operated equipment is power factor correction (PFC). PFC devices maximize the efficiency of the power grid by making the load “seen” by the power grid “look” resistive. The efficiency of resistive loads arises from the unvarying proportionality of the instantaneous voltage to the instantaneous current at any point on the AC sinusoidal voltage waveform. Since most of Europe presently requires all new electrical equipment to be power factor (PF) corrected, the requirement is expected to be mandated in the near future within the US.

AC utility power, while always sinusoidal, is provided to the point of use in a variety of RMS voltages. In the United States, 120 VAC single-phase is the most common, although in some circumstances 240 VAC or 277 VAC single-phase and 208 VAC or 480 VAC three-phase voltages are used. In Europe, 125 and 250 VAC single-phase is prevalent and in Japan, 100 VAC. “Universal input voltage” LED power supplies must accept input voltages over some portion of this voltage range (and optimally over this entire voltage range), widened by a tolerance (typically 10% less than the minimum and 10% above the maximum). Sensing the voltage and automatic adjustment without intervention or loss of performance is another design factor.

For safety, it is desirable for the output of the power circuit (connected to the LEDs) to include galvanic isolation from the input circuit (connected to the utility power grid). The isolation averts possible current draw from the input source in the event of a short circuit on the output and should be a design requirement.

Another design requirement is for the conversion from the incoming AC line power to the regulated DC output current to be accomplished through a single conversion step controlled by one switching power semiconductor. A one-step conversion maximizes circuit efficiency, reduces cost, and raises overall reliability. Switching power conversion in the circuit design is necessary but not sufficient to satisfy the one-step conversion requirement while capitalizing on the inherent efficiency.

For increased versatility, the LED driver circuit should allow dimming the LEDs' light output. The dimming circuit should incorporate galvanic isolation from both the primary (utility input side) and secondary (LED output side) of the LED driver circuit, and should operate from a separate low-voltage power supply. This architecture increases overall system safety, allows dimming of multiple LEDs, and permits the use of low-voltage wiring techniques to lower installation costs.

Typically, the color of high-output LEDs changes when the current supplied to them changes. To satisfy the requirement of no discernable color change as the LEDs are dimmed, the dimming circuit must employ an alternate to reducing the current through the LEDs, such as pulse-width modulation.

Regulatory standards, imposed through various European governmental directives (CE Mark) and in the US by the Federal Communications Commission (FCC), must be met by all new line-powered electronic equipment. These regulations center on electromagnetic interference (EMI) both radiated through the air and conducted through the input power connection. The circuit design must be compliant to all regulations in effect in all geographic localities where the device is sold.

While the primary application of this LED driver circuit is to drive a single series string of power LEDs, it should also have the capability for driving several strings at the same or different current levels. This will allow it to work in special applications as a driver for color-changing LEDs.

### Discussion of Related Art

Most power-factor-corrected (PFC) line-powered power supplies use boost topology because of its simplicity, low cost, and efficiency. For example, U.S. Pat. App. 20060022214 to Morgan, et al. and U.S. Pat. App. 20050231133 to Lys, and U.S. Pat. No. 6,441,558 to Muthu, et al. (2002) use such a PF correction. FIG. 1 shows a typical boost power-factor correction circuit. The incoming AC voltage is rectified by bridge rectifier D1. Capacitor C2 filters the incoming voltage, and acts as a small energy storage reservoir for the following switching stage. A PF correction and control IC, U1, monitors the incoming rectified AC line voltage and the DC output voltage stored on bulk capacitor C1. U1 controls semiconductor switch Q1 (typically a MOSFET), turning it off and on to control the current in inductor L1. When Q1 is off, the current previously stored in L1 flows through rectifier D2, charging bulk capacitor C1. The PF correction IC attempts to keep capacitor C1 charged to a nearly constant voltage (the circuit's output voltage), while attempting to keep the instantaneous input line current proportional to the instantaneous line voltage by modulating the off and on intervals of the MOSFET.

In a boost PFC circuit such as this, the DC output voltage must be greater than the maximum peak input voltage, under all conditions. For example, for a PF corrected circuit designed to operate from 240 VAC mains voltage, the output voltage must be set to be greater than 340 VDC (roughly the peak voltage from the 240 VAC waveform). Typically, 400 VDC is the chosen output voltage.

LEDs are nearly constant voltage devices. That is, their forward voltage drop changes very little as their forward current fluctuates. There may also be a significant amount of variation in the forward voltage drop from one LED to another. For these reasons, current regulation must be included in circuits that drive LEDs. For low power LEDs, it is common to start with a constant voltage source, and use a series (ballast) resistor to set the current through the LED(s), for example U.S. Pat. No. 6,949,889 to Bertrand (2005); and as shown in FIG. 2. However, this method of driving LEDs is not very efficient, as the ballast resistor dissipates a good portion of the total power. The current regulation is only as good as the tolerance of the resistor value, the LED forward voltage, and the supply voltage.

These reasons reflect that using a ballast resistor is not practical to drive high-power LEDs. A circuit designed to drive-high power LEDs should include a circuit that actively monitors the current in the LED string and adjusts the drive accordingly. For increased efficiency, a significant concern in high-power LED driver circuits, switching (rather than linear) power supply topologies must be used.

One traditional way to drive high-power LEDs efficiently from AC line input is to cascade a boost-PF stage with a buck current regulator stage. For example, U.S. Pat. No. 7,178,941 to Roberge, et al. (2007) uses this approach and FIG. 3 shows a block diagram of it. FIG. 4 shows additional detail. In the first section, the boost PF correction stage generates a DC rail voltage, which is stored on the bulk capacitor. The subsequent buck current regulator stage (composed of inductor L2, flyback diode D3, a current sensor, semiconductor switch Q2, and buck current controller IC U2) monitors the LED string current and makes adjustments as necessary to maintain the LED current at the desired value.

This approach is not an ideal for several reasons. First, the circuit requires two switching stages to convert the incoming AC line power to regulated DC LED current. There are greater switching losses and the circuit is more complex and expensive. Second, the DC output voltage from the PFC stage is typically much higher than the total series LED string voltage, resulting in a less than optimum buck LED current regulator stage. It must operate at a higher frequency than needed if the DC rail and LED string voltages were more closely matched, or a larger inductor must be used. Either alternative adds to circuit cost, complexity, and losses.

It is often desirable to have galvanic isolation between the input of a switching power supply and the output for example, U.S. Pat. No. 7,135,966 to Becattini (2006). Using a transformer to transfer the energy from the input (primary) side to the output (secondary) side is common. When regulation of the output voltage is required, a feedback signal is typically sent from the secondary side to the primary side through an optically coupled isolator. One of numerous circuit topologies used to accomplish this isolated transfer of energy is the isolated flyback topology, for example U.S. Pat. No. 5,513,088 to Williamson (1996), and shown in FIG. 5.

In an isolated flyback circuit, the transformer doubles as the energy storing inductor; energy from the primary circuit is stored in the magnetic field of the flyback transformer via one winding during the charge time interval, and is subsequently extracted to the secondary circuit via another winding during the discharge time interval. Note that one advantage to the isolated flyback topology is that the output voltage can be matched more closely to the required load voltage during the conversion process.

Isolated flyback circuits are generally designed to produce a regulated output voltage. The conventional method of building an isolated LED driver with LED current regulation would be to cascade two switching stages, for example U.S. Pat. No. 7,178,971 to Pong, et al. (2007), and as shown in FIG. 6. A conventional isolated flyback circuit would produce a regulated voltage presented to the secondary circuit. A subsequent current regulator circuit would regulate the LED current to the desired value.

### BRIEF DESCRIPTION OF THE DRAWINGS

FIG. 1—A typical boost power-factor correction circuit

FIG. 2—Driving a LED with a fixed voltage source and a ballast resistor

FIG. 3—A cascaded boost PFC converter and buck current regulator

FIG. 4—A more detailed cascaded boost PFC converter and buck current regulator

FIG. 5—An isolated flyback PFC circuit

FIG. 6—A cascaded flyback PFC and buck current regulated circuit

FIG. 7—A single-switch flyback PFC isolated and regulated current LED driver with universal input

FIG. 8—A discontinuous current mode PFC current

FIG. 9—A critical conduction mode PFC current

FIG. 10—A continuous mode PFC current

FIG. 11—A LED string current sense in a non-dimmed system

FIG. 12—A means of preventing PFC controller from compensating for a dimmer signal

FIG. 13—A microcontroller used to dim and to gate LED string current sampling

FIG. 14—A multiple LED series string driven in parallel

FIG. 15—Multiple series LED strings in parallel with constant current regulators in each string

FIG. 16—A simple current regulator

FIG. 17—Averaging LED string currents before sensing

FIG. 18—Sensing LED string currents separately

FIG. 19—Transistor used to both PWM dim and regulate string current

FIG. 20—One preferred embodiment of a universal input LED driver circuit with options

FIG. 21—A CAD schematic of another embodiment of a universal input LED driver

### DESCRIPTION OF PREFERRED EMBODIMENT

The goal of this design is to create an AC line powered LED string driver to power the LED string at a regulated current, while using only one switching/conversion stage. It must do this over a wide range of input voltages. Additionally, the circuit must do so while providing galvanic isolation between the primary and secondary circuits while presenting a power-factor-corrected (resistive) load to the incoming utility power.

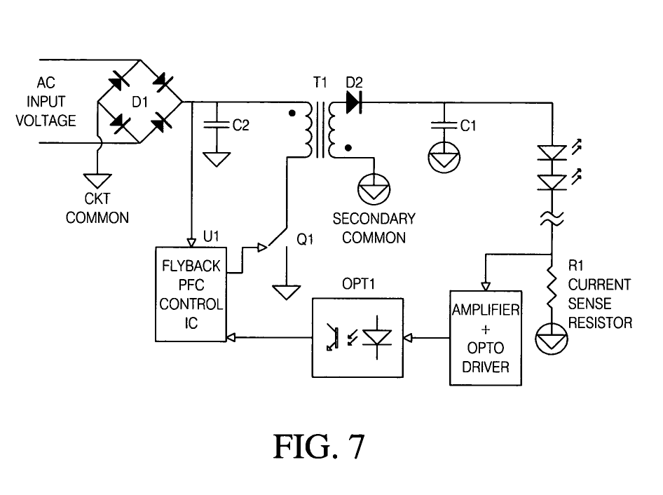

FIG. 7 shows the block diagram of a circuit designed to meet these requirements. The incoming AC voltage is full-wave rectified by bridge rectifier D1 and filtered by capacitor C2. The line-modulated (rectified) DC output voltage from the bridge rectifier is applied to the primary of flyback transformer T1. Current through the primary of T1 is switched by semiconductor switch Q1, which is controlled by power factor correction IC U1.

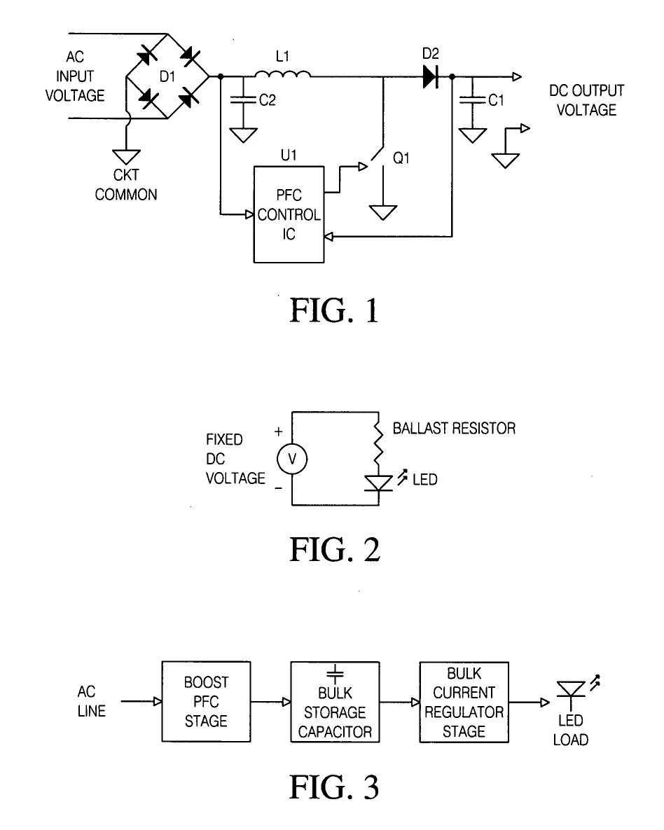

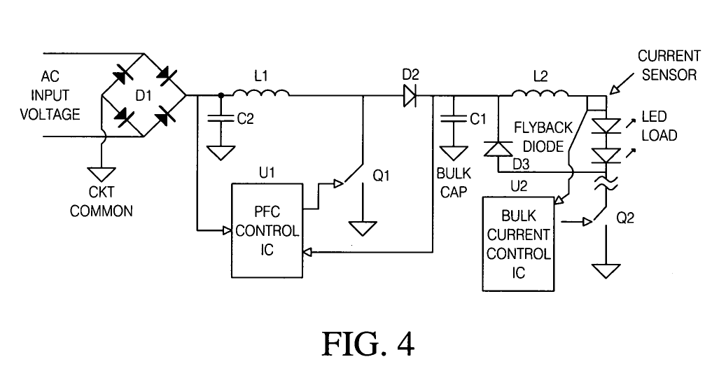

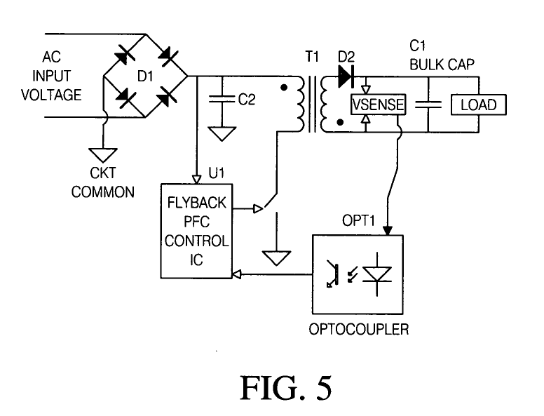

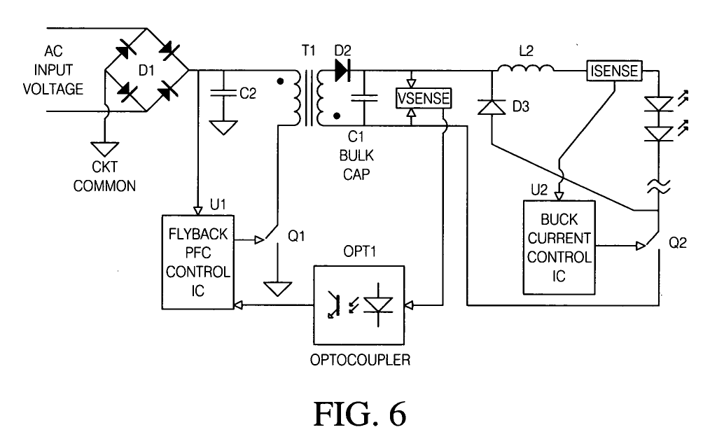

The primary of T1 “looks” like a simple inductor when Q1 is on and primary current flows because secondary rectifier D2 is reversed biased when Q1 is turned on. Consequently, T1 charges like a standard simple inductor in a typical non-isolated boost PF correction circuit (such as shown in FIG. 1). When Q1 turns off, however, the stored energy in the magnetic field of T1 causes the voltage across the primary to reverse polarity as the current attempts to continue to flow. The voltage across the secondary winding of T1 also reverses polarity as this occurs, resulting in secondary rectifier (D2) suddenly becoming forward biased. The energy that was stored in the magnetic field due to the current in the primary winding is discharged via the secondary winding, as current flows out through secondary rectifier D2 and into storage capacitor C1.

In a typical isolated voltage-output flyback circuit, the voltage stored on C1 is sampled using a voltage divider, and the proportional signal would be sent back across the galvanic barrier via an optocoupler to provide the controller IC (U1) with a voltage feedback signal. Regardless of whether the controller IC includes a PFC function, it would modulate the drive intervals of switch Q1 in an attempt to regulate the voltage stored on secondary storage capacitor C1. If U1 includes a PFC function, it would also modulate the conduction intervals of Q1 such that the current drawn from the line during each short conduction interval is proportional to the instantaneous line voltage during that conduction interval.

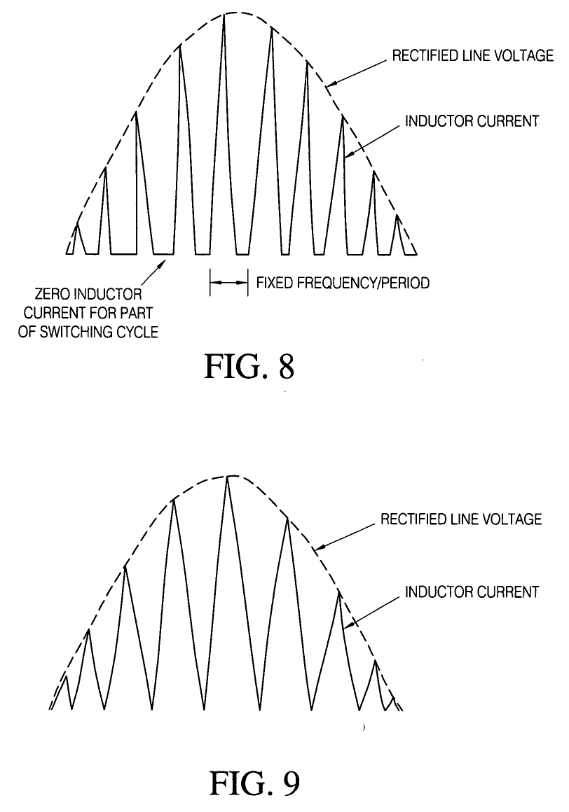

PFC control integrated circuits (as well as other power converter circuits) are available in several types, including discontinuous, continuous, and critical conduction modes. Discontinuous conduction mode PFC circuits are the simplest. The circuit typically runs at a constant frequency. It is designed to allow the inductor current to decay to zero and remain at zero for some period while the switch is off. After this delay period, the switch is turned back on to start the next cycle. The peak inductor current flow is naturally modulated by the rectified line voltage, as shown in FIG. 8. Critical conduction mode PFC circuits turn the switch back on exactly when the inductor current decays to zero, as shown in FIG. 9. Again, this being a PFC circuit, the rectified line voltage modulates the peak current.

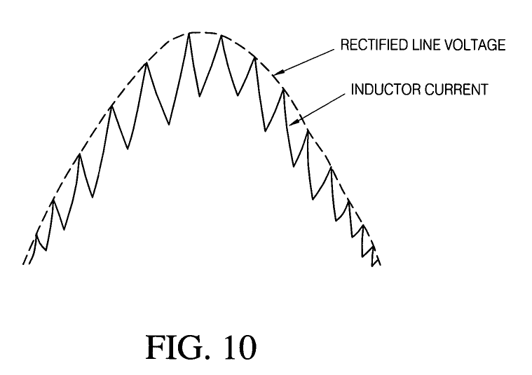

Continuous conduction mode PFC circuits do not allow the inductor current to decay to zero while the switch is off before the next cycle. The current in the inductor ramps up and down in a saw-tooth waveform, modulated by the rectified line voltage, as shown in FIG. 10. Continuous conduction mode circuits require more complex controls than discontinuous conduction mode circuits, but provide increased inductor efficiency and require less input filtering.

The invention described herein is applicable to all three conduction mode PFCs in addition to other power conversion circuit designs.

One key purpose for the circuit described herein is to drive a string of LEDs at a constant current level, as shown in FIG. 7. The current in the LED string is monitored as a voltage drop across a small resistor at one end of the string (normally the cathode or most-negative end). The circuit design minimizes the voltage drop across current sensing resistor R1 in order to minimize power losses.

A primary point of departure from traditional designs in the circuit described in this patent application involves the signal fed back to the controller IC. This design does not use the voltage across the bulk capacitor, as in a traditional circuit, for the feedback to the controller IC. Instead, the current in the LED string, measured as the proportional voltage drop across a sensing resistor, is used for the feedback signal.

The design departure provides several notable differences from traditional voltage controlled output circuits:
The PFC controller IC used in this circuit may be any type of PFC IC designed for use in voltage-output PFC circuits; there is no need for an application specific designed integrated circuit to accommodate the current-output of this circuit.
The conduction intervals of switch Q1 are now modulated to control the LED string current, rather than the secondary voltage stored on C1. The actual voltage stored on C1 is primarily a function of the sum of the forward voltages of the LEDs, the string, and does not have a direct input on the control signals fed back to the primary side controller.
By directly monitoring and controlling the LED string current, the circuit is able to convert AC line voltage to DC LED string current with only one switching stage. This greatly simplifies the circuit, saving both cost and physical volume and it improves circuit efficiency.
The output (LED string) voltage may vary due to normal variations in LED forward voltages, the number of LEDs in the string, temperature, or other factors. However, since the LED string current is directly regulated, these voltage variations will have no significant impact on the LED string current so long as the total string voltage is within the compliance range of the circuit.
The circuit automatically compensates for variations in AC input voltage. For example, an increase in incoming line voltage causes increased transformer primary currents for a fixed switch conduction time, and at the same phase point in the incoming sine wave. This increased primary current causes greater current flow into bulk capacitor C1 when the switch is in its off interval; the voltage on the bulk capacitor increases, resulting in an increase in the LED string current.
As the V1 curves of LEDs reflect, a small change in forward voltage causes a large change in current. This increased string current is detected by the current sense resistor and fed back to the control IC. The control IC sees a feedback signal greater than its reference signal and reduces the conduction times of the switch to compensate. In a very short period, the circuit will reach a new equilibrium point with the LED string current at very nearly the same value as before the input voltage change. This feature permits the realization of universal input voltage sensing capability with automatic compensation.

Bulk capacitor C1 acts as an energy reservoir to buffer the conflicting requirements of power-factor-corrected input and constant-current output of the circuit design. By definition, the input power to the PFC circuit varies as the input voltage passes through complete cycles. In fact, the instantaneous input power at any phase angle along the sine wave is proportional to the square of the voltage at that phase angle. Conversely, since the LEDs are nearly constant voltage devices, driven at an essentially constant current, the output power is fixed. Hence, C1 absorbs energy when the incoming AC voltage is near its maximum magnitude, and releases energy when the incoming AC voltage is near its minimum value.

C1 also reduces the ripple in the LED string current. The LEDs are most efficient when run at a constant current. Some ripple in the current will exist, however, corresponding to the charging and discharging of capacitor C1. The greater the value of C1, the less relative ripple will exist in the LED string current.

One desirable feature for any light source, including a LED-based light source, is the ability to dim. The most obvious way to dim LEDs is to decrease the forward current through the LEDs. However, dimming by reducing the current can result in a shift in the color of the LEDs, which may be detrimental.

A better approach for dimming LEDs is by using pulse width modulation. The LED string is driven at a fixed, high current while they are on. With pulse width modulation, the LEDs turn on and off at a frequency high enough to avoid visible flicker but with reduced average light output, in proportion to the percentage of time (duty cycle) that the LEDs are emitting during each of the switching cycles.

Since the LEDs are operating at normal, high current levels when they are on, color is unaffected. This dimming technique takes advantage of the fact that the eye integrates the light that it receives. As long as the flashing frequency is sufficiently fast, the eye perceives no flicker. In practice, any flash rate over about 100 Hz is sufficiently fast for the eye's light integration to eliminate the perception of flicker while perceiving the reduced intensity level.

Many PWM dimming systems operate at low frequencies, 100-200 Hz. However, dimming at a rate in this range in a PF corrected circuit introduces unwanted problems because of the nearness of the dimming PWM rate to the rectified line frequency, typically 100 or 120 Hz. This closeness can cause the input power to fluctuate as the dimming frequency and the rectified line frequency beat against one another. The result can be a visible pulsation in the light intensity, an increase in harmonics in the current drawn by the circuit from the AC line, and/or a decrease in power factor.

One way to avoid these problems is to PWM dim at a sufficiently high frequency to prevent these beat frequency problems. Using a PWM frequency of 20 kHz or above also ensures any mechanical vibration due to the dimming signal is inaudible.

There may be advantages to using a lower frequency (such as 100-200 Hz) for collectively dimming multiple LED strings, in spite the apparent advantages of using a higher frequency (such as 20 kHz) for pulse width modulation. For example, wave shaping to reduce the EMI emitted by the distributed dimming signal is far simpler at lower frequencies. In that case, a circuit can be used to convert the low frequency distributed dimming signal to a high frequency PWM signal that actually controls the LED string currents. A microcontroller is ideal for this purpose.

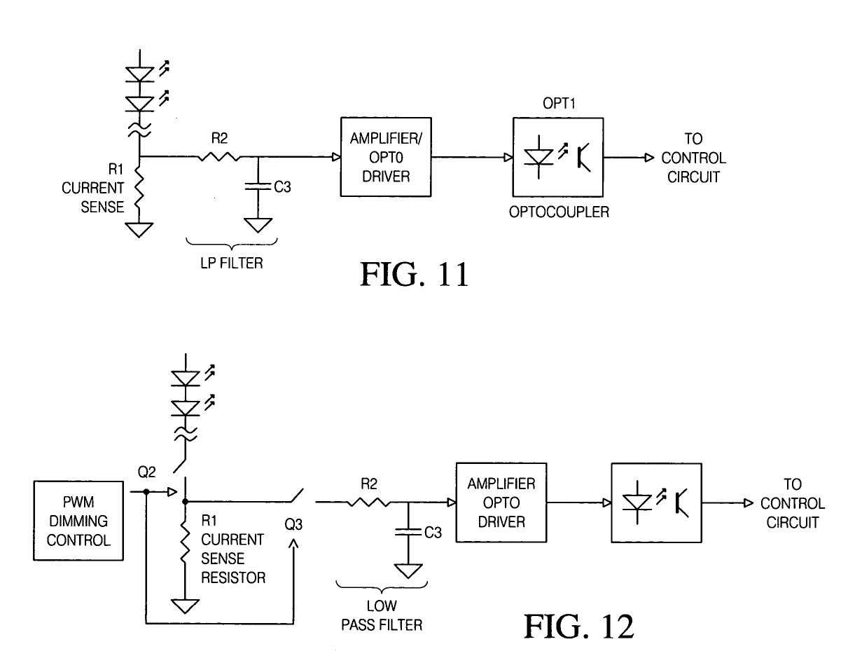

FIG. 11 shows a typical current sense circuit for the LED string in a non-dimmable application. As previously discussed, the current through the LED string is measured with current sensing resistor R1. The resulting signal is averaged with the low-pass filter (composed of resistor R1 and capacitor C3), to filter out the ripple in the current waveform and provide an average of the LED string current. This signal is then amplified and ultimately passed to the control chip U1.

However, if the same filtering and sensing circuit is used when the LED string is PWM dimmed, the average current will drop in proportion to the duty cycle of the dimming signal. The control IC will receive an indication of reduced LED current, and increase the switch (Q1) duty cycle in an attempt to compensate for the dimming.

One way to avoid this problem is shown in FIG. 12. Switch Q2 is the PWM dimming switch; it is pulse width modulated to reduce the LED string current in order to provide the desired average output light level. By adding another switch (Q3) controlled by the same signal as the dimming switch, the current sense signal is connected to the filter only when the LED current is flowing. Therefore dimming is achieved while preventing the PFC controller from compensating for the dimming PWM control, and still maintaining a PFC corrected power input.

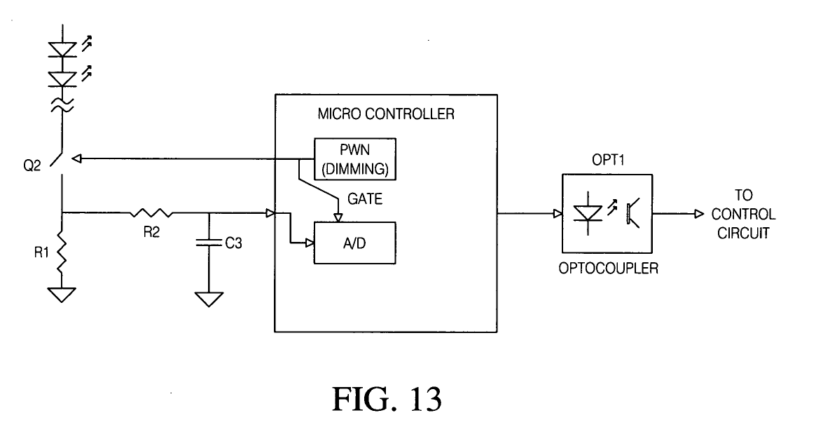

An alternate method of regulating the current only during the PWM dimming “on” period is with sampling techniques, as shown in FIG. 13. This is particularly applicable when a microcontroller is used to generate the PWM dimming signal. Provided the current sensing filter is sufficiently fast, the microcontroller (or other controlling circuitry) can sample the LED string current only during the “on” portion of the dimming cycle.

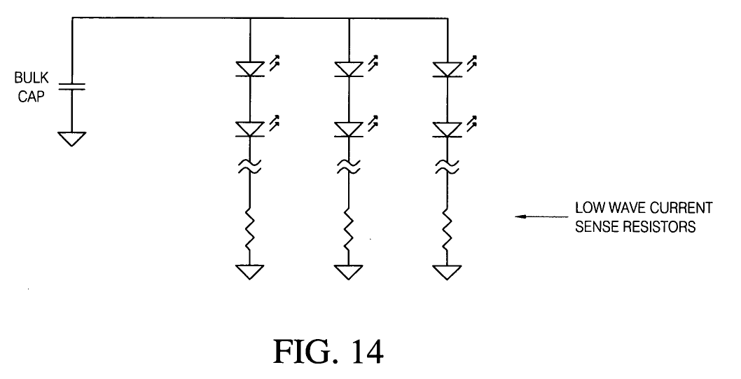

In some circumstances, it is desirable to drive multiple series strings of LEDs with a single circuit (avoiding the expense of multiple circuits). For example, if color changing is desired, the circuit may need to drive strings of red, green, and blue LEDs. If more than one series string of LEDs are connected in parallel and driven from the same voltage source (the bulk cap, in this case), as shown in FIG. 14, the string with the lowest total forward voltage will consume all or nearly all of the current. A means of forcing the parallel strings of LEDs to share current is needed.

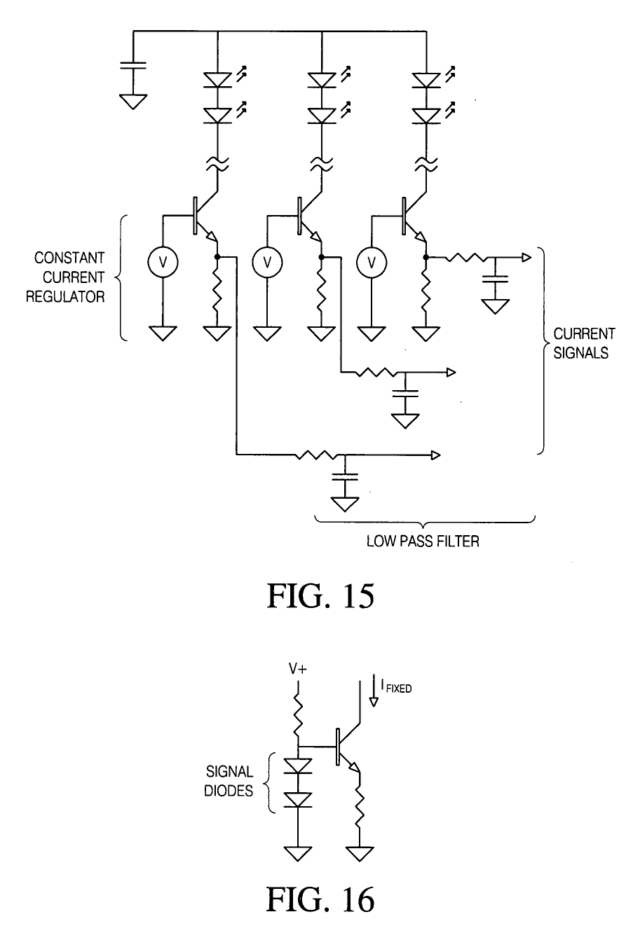

One way of solving this problem is to insert a constant current regulator circuit at the base of each string, as shown in FIG. 15. Each of these current regulators will regulate the maximum current that passes through its associated string; that current is set by the value of the base resistor and the value of the voltage source that is connected to the base of the transistor. If desired, one voltage source can be used as a reference on all of the regulator transistors. Note that as shown in FIG. 15, the current setting resistor in the constant current regulators can also double as the current sensing resistor.

A very simple form of constant current regulator is shown in FIG. 16. The voltage source attached to the base of the transistor is two series connected diodes, fed with a resistor from a more positive voltage source. One of the two diodes compensates for the BE junction of the transistor. Therefore, the collector (and LED string) current is regulated at a maximum of one diode drop (about 0.7 volts) divided by the value of the current set resistor (the emitter resistor).

It is not necessary that all of the LED strings are regulated at the same current. By using different Base/Emitter bias resistor values, each of the strings may be set to regulate at a different current value without otherwise affecting the global operation of the circuit. This can be very useful when combining different colored strings of LEDs create unique colors; the current required by each LED string will not necessarily be equal.

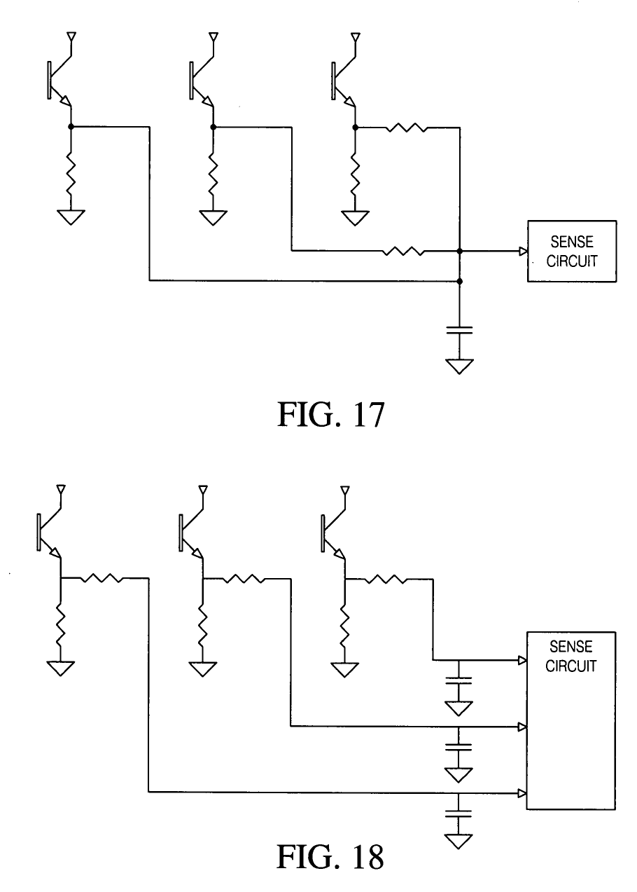

In cases where the multiple LED strings must be driven at fixed current levels and never dimmed), the sensed current signals from each string's current sense resistor can be averaged together and then sensed (shown in FIG. 17), or sensed separately (FIG. 18). In practice, as the voltage on the bulk capacitor increases, the LED strings to begin to conduct sequentially, starting with the one with the lowest total string voltage and finishing with the string with the largest total string voltage. As each string reaches its current regulation value, its current will plateau. In order to have full current (and dimming) control over all LED strings, the bulk capacitor voltage must be sufficiently high to drive the LED string with the greatest series voltage at the desired current level.

In order to maximize the efficiency of the circuit, it is important that the current regulator circuitry in these multiple string designs recognizes when all strings are operating at their maximum (regulated) current values, and provides no additional power to the bulk capacitor beyond this point. While the current regulator circuits for each string will continue to regulate current if more power is supplied, the additional power will simply be wasted in the regulator circuits, with the possible additional disadvantage of overheating and circuit damage.

One preferred method of detecting when all strings have reached their current regulation value is to monitor the current levels with a microcontroller. This is particularly applicable when a microcontroller is in place to generate the PWM dimming signals.

Dimming of each of multiple LED strings is possible, either as a group (to the same duty cycle or relative brightness levels) or independently (where each is set to its own level). Independent LED string dimming is particularly useful when the LED strings are of different colors, and use of differential dimming allows changing the color that results from mixing the LED strings' light outputs. When dimming multiple strings, it is still desirable to keep the “on” current of each string at the desired, pre-established level. The current measuring techniques described above (refer to FIGS. 12 and 13) are applied to each channel, independently.

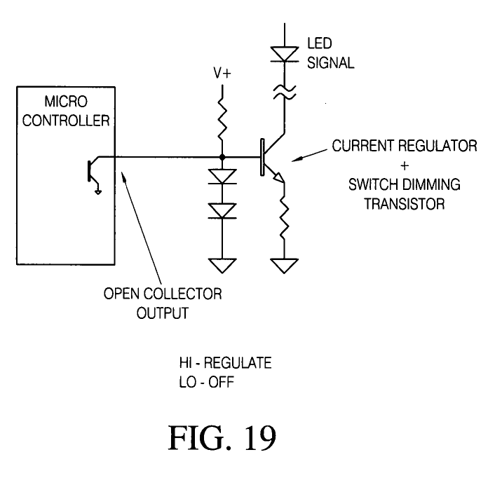

In the interest of simplifying the circuitry, the same semiconductor switch can be used to both PWM dim and regulate the current in each series LED string, as shown in FIG. 19. The base of the transistor may “float” (to regulate current) or be pulled to ground (to turn off current for PWM dimming). This technique is particularly useful when controlling the transistors with the open-collector output of a microcontroller.

In order to limit the radiated and conducted EMI from the circuit, it is necessary to employ both line filters (for conducted noise) and shielding (for radiated noise). In many instances, these noise-limiting components can account for a large portion of both the cost and physical size of the circuit. Any circuit design features yielding a reduction of the generated EMI (and reducing the size and expense of filtering components) is very desirable.

In recent years rectifiers made from a new semiconductor material, silicon carbide (SiC) have been developed. One great advantage to SiC rectifiers is their lack of reverse recovery time. In a switching power supply circuit such as the one described herein, this lack of reverse recovery time reduces EMI generation (in this case, by the secondary rectifier). This can deliver significant reduction in the size and cost of the EMI filtering components, providing a significant cost advantage. This advantage will increase significantly as the cost of power LEDs drops and as they become the preferred solution for general illumination.

In the actual working circuit, two separate isolated low-voltage power supplies are required, to operate the circuitry on both sides of the galvanic barrier. A two-winding inductor is required by the design: two additional windings can be added to this inductor to provide the low voltage DC bias supply needed, at little additional cost.

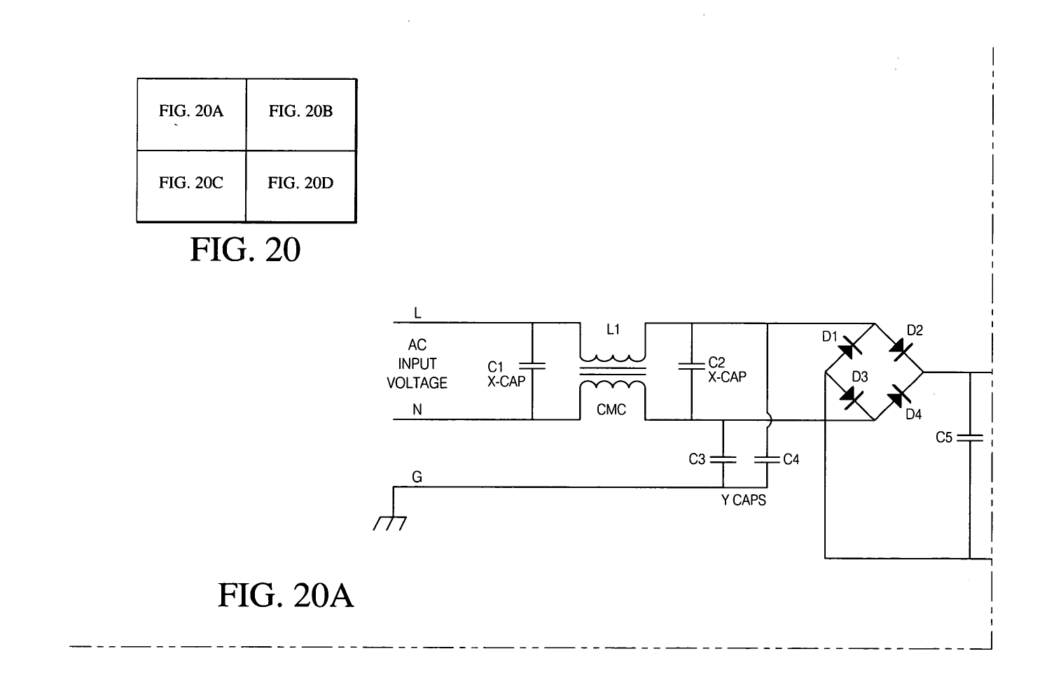

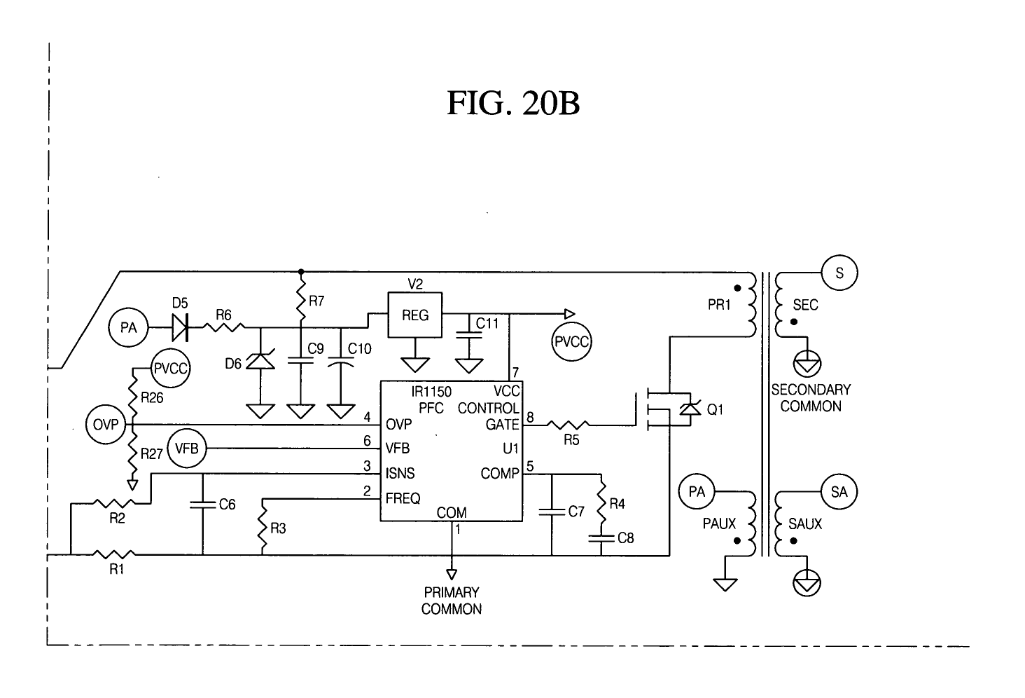

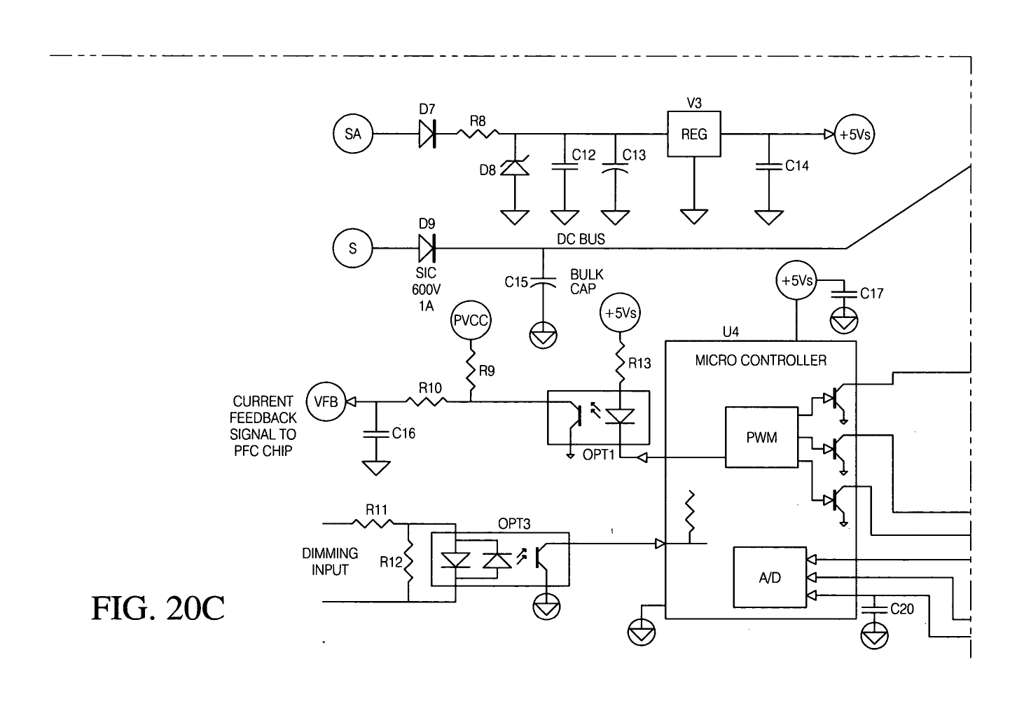

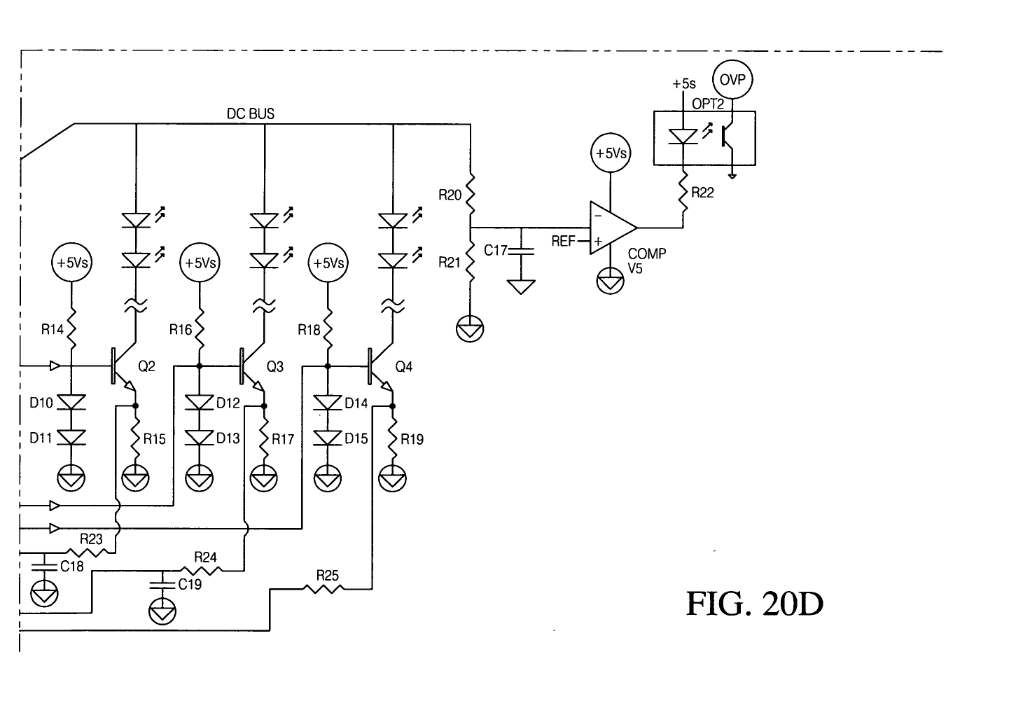

FIG. 20 is a schematic of one preferred embodiment of the circuit, including most of the features described above. The operation of the circuit is as follows:

Utility AC power, at 50 or 60 Hz and 80-310 VAC, enters the circuit at the upper left corner of the schematic. Incoming power passes though an EMI filter composed of X-capacitor C1, common mode choke L1, X-capacitor C2, and Y-capacitors C3 and C4 (which shunt noise to ground). The voltage passes though the rectifier bridge (D1, D2, D3, and D4) to filter capacitor C5, a low value ceramic capacitor serving as a short-term energy reservoir for the high frequency switching circuitry that follows.

The output from the bridge rectifier and filter capacitor passes to the primary of multi-winding inductor/transformer T1. MOSFET Q1, controlled by Power-Factor Correction IC U1, controls the current flow through T1's primary winding.

While many different PFC ICs are available, the International Rectifier part IR1150 was chosen for use in a preferred embodiment. The IR1150 offers multiple advantages, such as not needing to sample the input voltage directly and constant current mode operation without the circuit complexity usually associated with it.

U1 monitors instant incoming line voltage, measured at sensing resistor R1. A low-pass filter composed of resistor R2 and capacitor C6 remove high frequency components of the signal from R1 before presentation to the input of U1. The value of R3 sets the operating frequency of U1. Capacitors C7 and C8 and resistor R4 are compensation components that set the frequency response and establish the stability of the circuit. U1 drives the gate of MOSFET Q1 through gate resistor R5, which limits ringing on the gate of the MOSFET.

U1 uses the information from R1 and secondary LED string current information fed back via an optocoupler, to modulate the MOSFET drive signal. This dual functionality regulates secondary LED current to the correct value while the input power from the utility is drawn in a PF corrected (resistive) fashion.

T1's primary side auxiliary winding Pₐᵤₓ provides power for the primary side bias circuitry. Diode D5 rectifies the output of this winding, and resistor R6 limits the surge current from the winding in the event of a transient. Zener diode D6 clamps the voltage at filter and bulk capacitors C9 and C10. Resistor R7 provides a low level of leakage current to charge C9 and C10 when the circuit is first energized, before power being provided by winding Pₐᵤₓ. Regulator U2 provides a regulated 15 volts for use by the primary side circuitry. Capacitor C11 is an output capacitor required for regulator stability as well as a bypass filter for U1.

Similarly, T1's secondary side auxiliary winding Sₐᵤₓ provides power for the secondary side bias circuitry. Diode D7 rectifies the output of this winding, and resistor R8 limits the surge current from the winding in the event of a transient. Zener diode D8 sets the voltage limit at filter and bulk capacitors C12 and C13. Regulator U3 provides a regulated 5 volts for use by the secondary side circuitry. Capacitor C14 provides required regulator stability.

The output from T1's secondary winding is fed to rectifier D9. When Q1 is on current builds through the primary winding of T1, diode D9 is reverse biased and no secondary current flows. When Q1 turns off, the polarity of T1's primary and secondary windings suddenly changes as primary current tries to continue flowing. Rectifier D9 is suddenly forward biased, and the energy stored in the primary (having no primary conduction path) transfers to the secondary, causing flow of current through D9 and charging bulk capacitor C15.

D9 must have a very short reverse recovery period. When MOSFET Q1 first turns on, reversing the polarity of the transformer windings, D9 looks like a short until the charge is swept from D9's junction. During the reverse recovery period, D9 looks like a short, reflected to the primary of T1. Because of this apparent short, very large current flows when the MOSFET first turns on, imposing high stress on the MOSFET and generating a large EMI signature. Silicon carbide rectifier D9, having no recovery period, was chosen to avoid these problems caused by conventional rectifiers.

The positive rail voltage rail stored on bulk capacitor C15 connects to the series LED strings at the output of the driver. Although only three series LED strings are shown, any reasonable number of LED strings may be employed, provided the circuit can supply sufficient power to drive them all.

Once bulk capacitor C15 has charged to a voltage greater than the minimum series LED sting voltage, that string will begin to conduct current (when its associated control transistor is turned on). As the rail voltage continues to rise, the other series LED strings will also begin to conduct as the potential exceeds the series voltage of each string (again, assuming the associated control transistor is turned on).

Transistors Q2, Q3, and Q4 are the control transistors for the three separate series LED strings shown. No control transistors are required if the circuit is driving a single LED string and dimming is not needed. The base of each of these control transistors connects to an open collector output on the microcontroller.

The microcontroller controls the individual LED strings in the following manner: If an open collector output transistor in the microcontroller turns on, the associated control transistor's base is pulled toward ground, and the control transistor (along with the connected series LED string) will be turned off.

When a microcontroller's open collector output turns off, the associated control transistor is free to operate normally. A resistor (such as R14 for Q2) pulls up the base of each control transistor but not above voltage clamp set by two series-connected diodes (D10 and/D11 for Q2). This biases the base of the transistor at two diode forward voltage drops (about 1.4 volts) above circuit ground.

One of these two diode drops compensates for the control transistor's Base-Emitter junction voltage drop, leaving approximately 0.7 volts across the current setting resistor (R15 for Q2). The value of the current setting resistor sets the control transistor's emitter current. Since the collector current (and therefore the series LED string current) is nearly the same as the emitter current, this resistor sets the LED string current for that branch.

In order to have the needed current flow in all of the series LED branches, bulk capacitor C15's charge must be to a potential greater than voltage than the highest series LED string voltage requirement. The current in each of the branches is determined by measuring the voltage across the associated current set resistors (R15 for Q2).

These current signals, filtered by a low pass filter (composed of R23 and C18 for Q2), are monitored by the microcontroller (U4), using an internal analog to digital converter (A/D). The microcontroller senses all of the connected series LED channels and sends a signal indicating the lowest channel's current back to the PFC control IC located in the primary circuit (U1). The PFC uses this signal to adjust the current to the correct value.

The LED strings are dimmed by pulse width modulation (PWM). During the on portion of the PWM cycle, the LEDs are at full intensity; eliminating current based color shift. Since it is desirable to regulate the current only during the on period (rather than averaging over the entire on/off cycle), the microcontroller only samples during the period when it has a channel turned on.

The microcontroller sends an analog signal representing the LED strings current back to the PFC control IC through digital optocoupler OPT1. The optocoupler's duty cycle is proportional to the measured LED string current. A low-pass filter, composed of R10 and C16 on the PFC side of the optocoupler, reconstructs the analog voltage corresponding to the LED string current. R9 is a pull-up resistor required by the output of the optocoupler.

The over-voltage and shutdown pin on the PFC controller IC (pin 4) is held within a nominal range by the voltage divider formed by R26 and R27. If the bulk capacitor charges up to a sufficiently high voltage (presumably due to a failure in some other portion of the circuit), the inverting input on comparator US will exceed the voltage of the reference connected to the non-inverting input. R20 and R21 divide the voltage down, and capacitor C17 is a noise filter to prevent false trips).

When an over-voltage occurs, the output of the comparator will go low, turning on optocoupler OPT2. This will pull U1's OVP pin below 0.6 volts, disabling the PFC IC's output and preventing bulk cap C15's voltage from rising any higher. Adding a latch function (if desired) will insure the circuit remains disabled after an over-voltage fault until power is cycled.

Having an external PWM dimming input to the circuit may be desirable. If so, the PWM signal would drive optocoupler OPT3. A voltage of sufficient magnitude, of either polarity, turns on optocoupler OPT3. Its output of OPT3 feeds into the microcontroller. Resistor R11 limits the current through the optocoupler's LEDs, and resistor R12 keeps noise from turning on the optocoupler. This circuit is designed such that the lack of an input from the dimming optocoupler indicates “full brightness”, and the circuit can be present without an external dimmer or further modification.

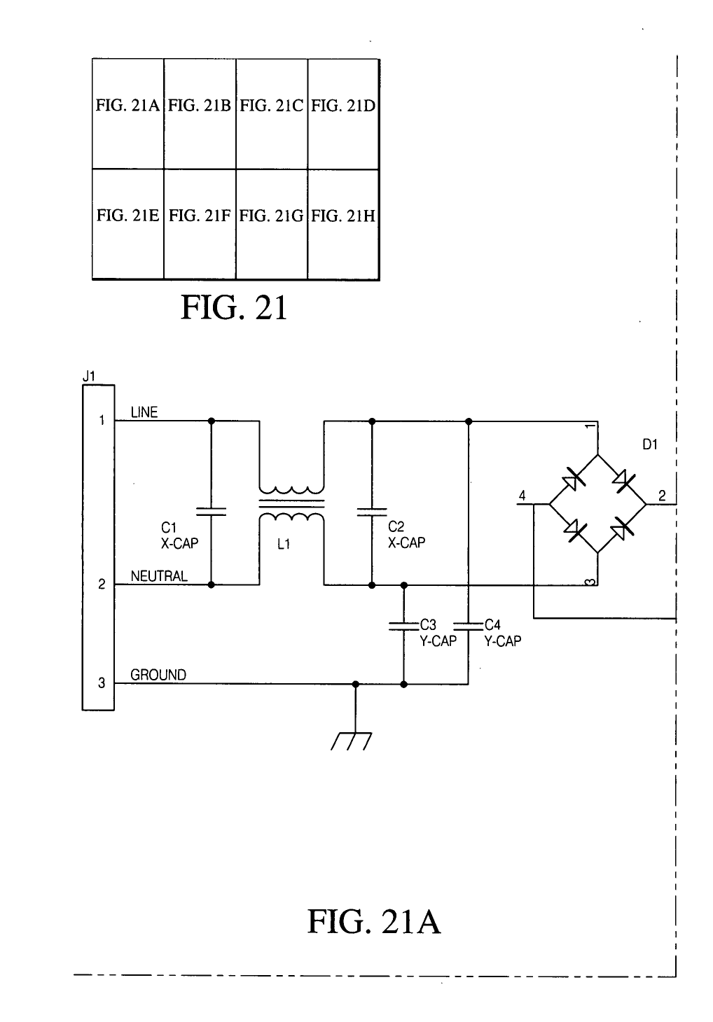

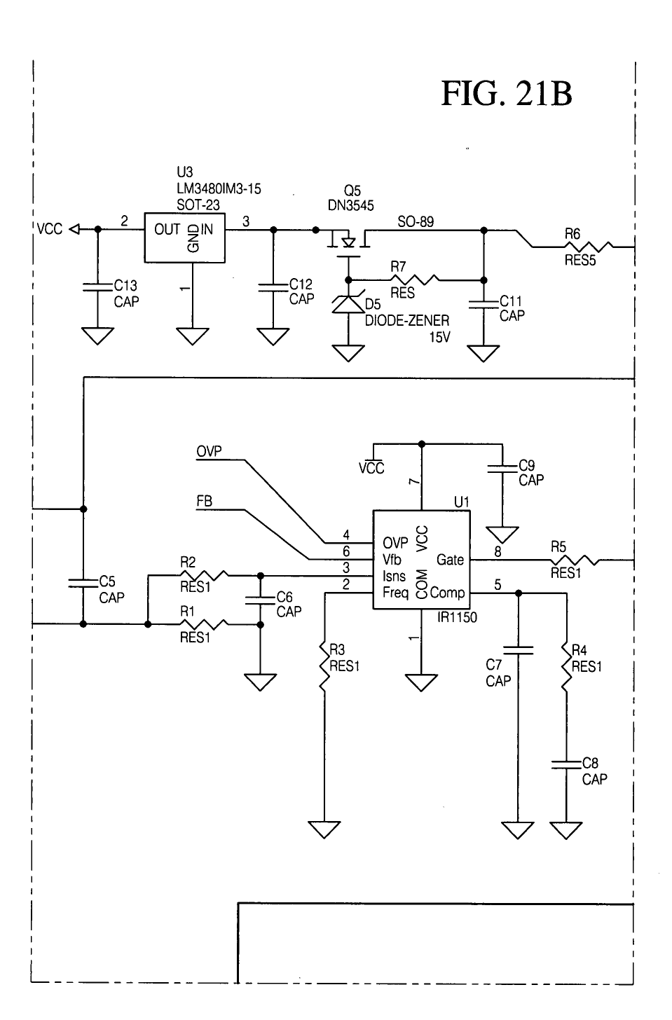

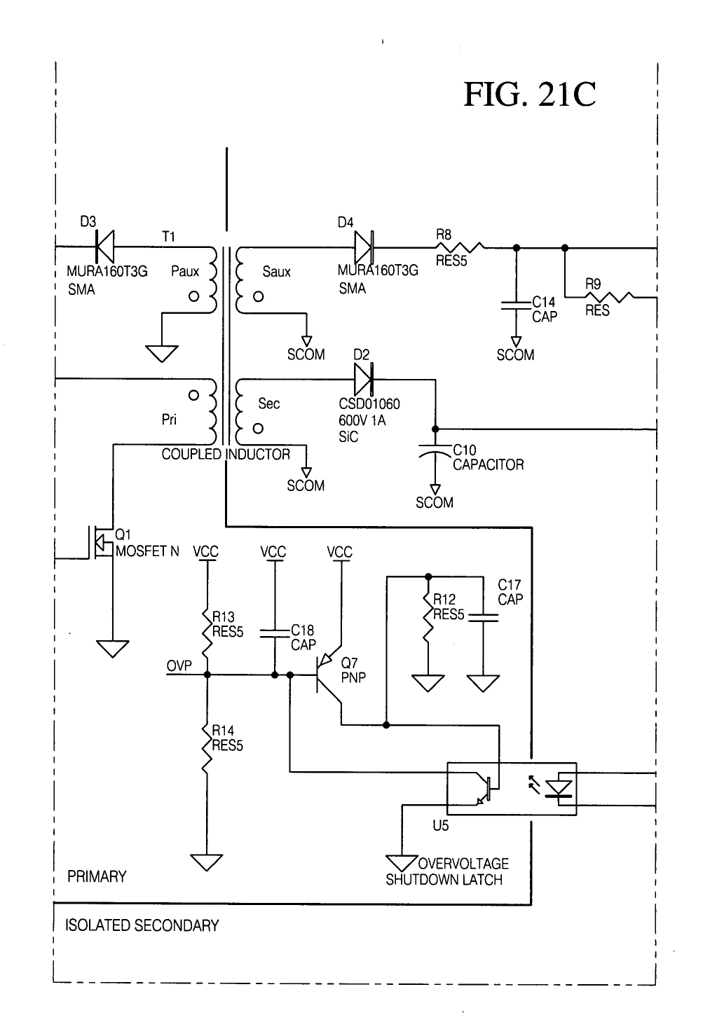

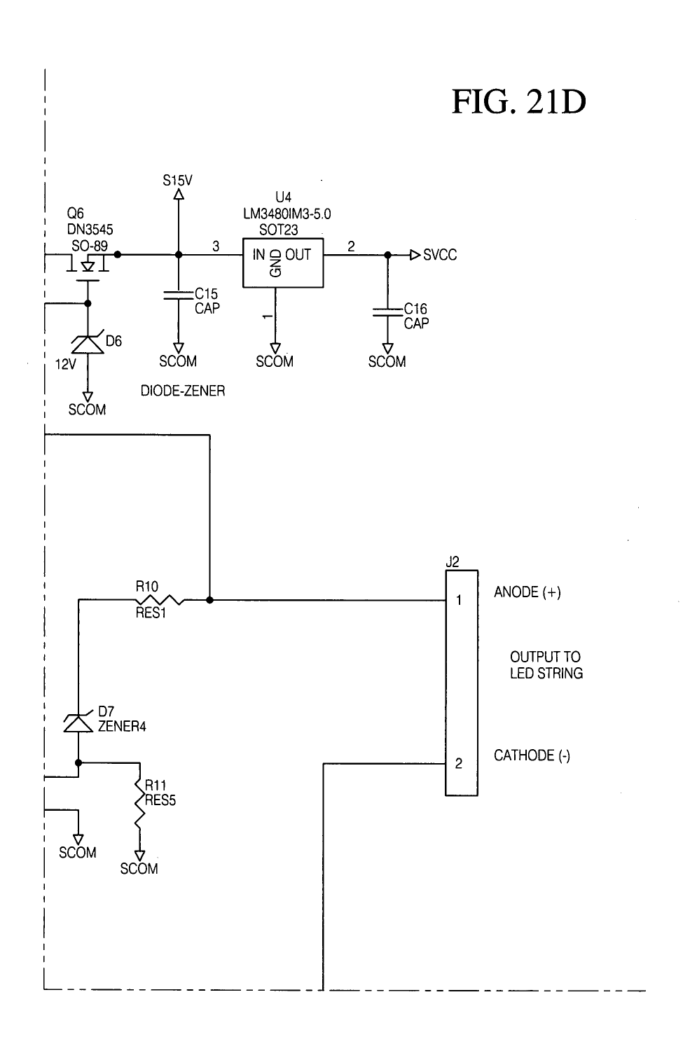

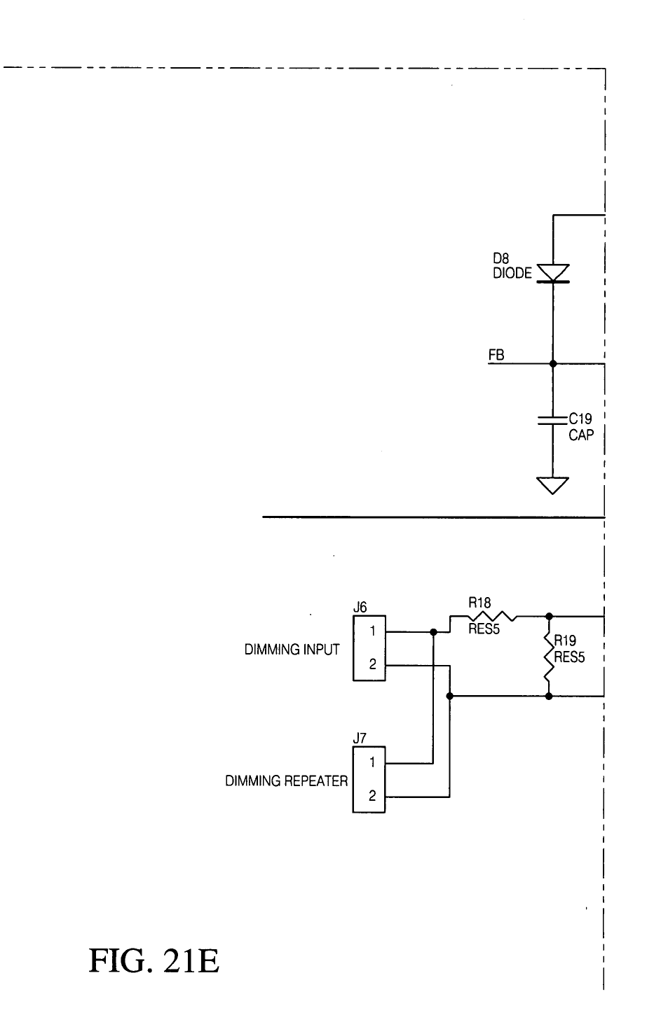

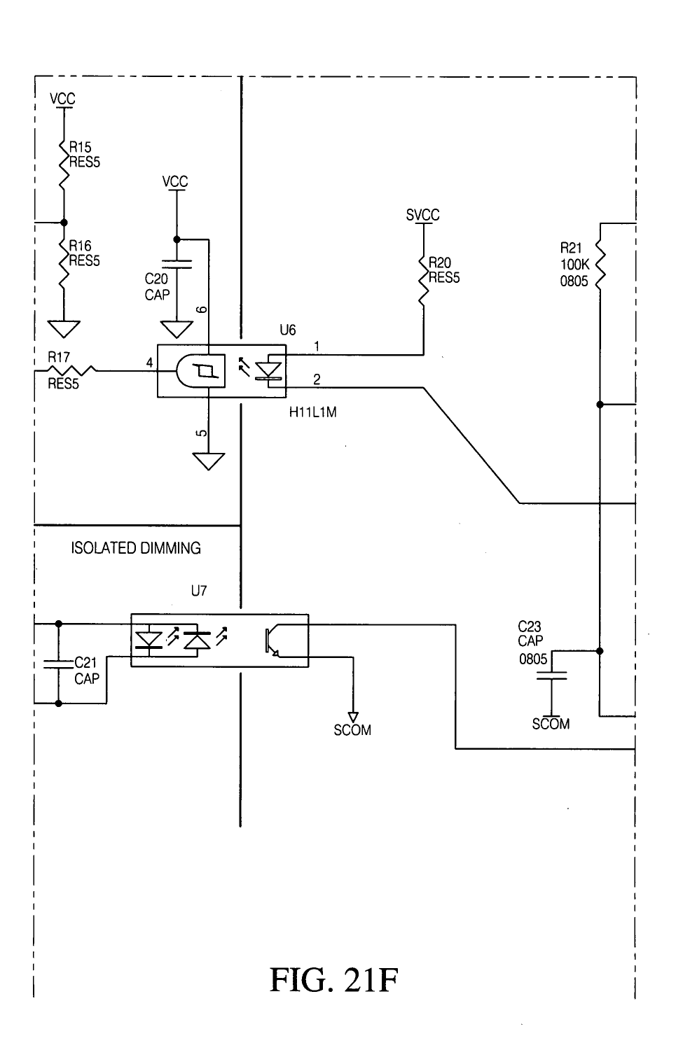

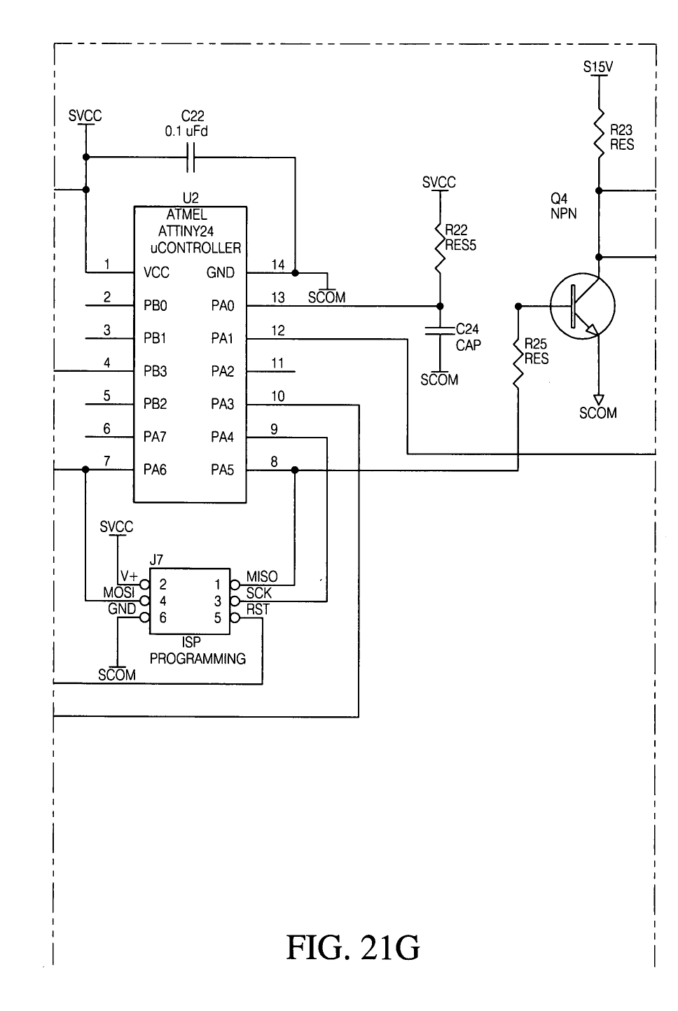

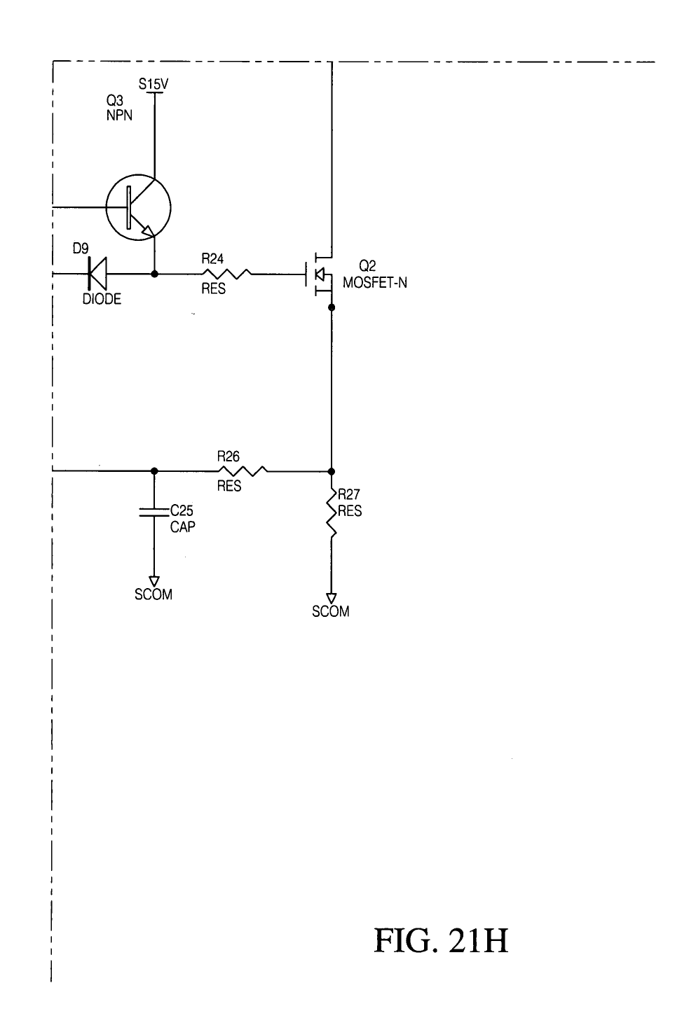

FIG. 21 is a CAD schematic of an alternative embodiment of the Universal Input LED Driver. This embodiment uses some, but not all, of the possible features discussed in the previous disclosure and which are included in the comprehensive schematic included as part of that disclosure. The main feature contained in the comprehensive schematic, but absent from the CAD schematic, is the ability to drive and separately control the current in multiple output channels. The CAD version is intended to control a single series string of power LEDs. All other features are present, including the most fundamental to the invention: a single stage, power factor corrected, universal input voltage, conversion from AC line voltage to DC output current, with output regulation for line and load variations.

I claim:

1. A LED string driver circuit consisting of:
A. A universal AC input;
B. A single stage power converter that converts power provided by the universal AC input to regulated DC current in the LED string;
C. A LED light source directly connected to the single stage power converter;
D. A power factor correction unit that controls current provided by the single stage power converter;
E. A galvanic isolation barrier;
F. An input section directly connected to the AC input; and
G. An output section that is directly connected to and powers the LED light source and is galvanically isolated from the input section by a galvanic isolation barrier.

2. The LED string driver circuit of claim 1, where said LED light source further consists of a plurality of LEDs.

3. The LED string driver circuit of claim 1, where said single stage power converter contains a Silicon Carbide rectifier.

4. The LED string driver circuit of claim 1, where said LED light source emits a constant color of light throughout the LED's dimming range.

5. The LED string driver circuit of claim 1, where said output device includes an open secondary circuit detection function that keeps the primary voltage from appearing at this output of the device when no load is applied.

6. The LED string driver circuit of claim 1, further comprising a dimming function that is accomplished by a linear change in regulated LED current, and can be accomplished with pulse width modulation of the LED current.

7. The LED string driver circuit of claim 6, where said dimming function is controlled with a separate dimming circuit, and remotely located from the LED driver circuit.

8. The LED string driver circuit of claim 6, where said dimming function uses a dimming signal to control multiple LED driver circuits, and is optically coupled to the LED driver circuit.

9. The LED string driver circuit of claim 1, further comprising a red, green, blue output function.

10. The LED string driver circuit of claim 9, where said red, green, blue output function is used to implement a color change.

11. The LED string driver circuit of claim 1, where said galvanic isolation barrier allows for power transfer via a multiple-winding inductor.

12. The LED string driver of claim 11, where said multiple-winding inductor is provided with one or more auxiliary windings on the primary and/or secondary of the galvanic barrier.

13. The LED string driver circuit of claim 1, further comprising a control signal indicating the LED current is sent from the secondary to the primary side of the galvanic barrier.

14. The LED string driver circuit of claim 13, where said control signal can be sent across the galvanic barrier with an optical isolator.

15. The LED string driver circuit of claim 1, further comprising a power factor correction stage to correct the power factor of the power drawn from the AC input.

16. The LED string driver circuit of claim 15, where said power factor correction uses a simplified continuous-conduction-mode technique that does not require direct line voltage sensing.

17. The LED string driver circuit of claim 1, further comprising a soft-start feature to ramp the LED current from zero up to the desired value.

18. The LED string driver circuit of claim 1, further comprising a secondary over-voltage detection feature.

19. The LED string driver circuit of claim 1, further comprising multiple strings of LEDs in parallel where the current in each string of LEDs can be independently regulated.

20. The LED string driver circuit of claim 1, further comprising a separate secondary-side voltage sensing circuit that monitors bulk capacitor voltage and can send a “shutdown” signal to the primary side controller in the event that the bulk capacitor voltage exceeds a pre-established threshold or an output open circuit is detected.
